(19) United States
(12) Patent Application Publication
(10) Pub. No.: US 2008/0095966 A1
(43) Pub. Date: Apr. 24, 2008

(54) Method for sealing an opening in a component

(75) Inventor: Stefan Jatzke, Ebertsheim (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH

(21) Appl. No.: 11/975,475

(22) Filed: Oct. 19, 2007

(30) Foreign Application Priority Data
Oct. 20, 2006 (DE) 10 2006 049 609.4

(51) Int. Cl. B32B 3/26

(52) U.S. Cl. 428/63

(57) ABSTRACT

In a method for sealing an opening in a component (18) a sealing plug (10) is produced in a shape of use which ensures a sufficient tightness. The sealing plug (10) is treated thermally so that the sealing plug (10) takes on a mounting shape which differs from the shape of use. The sealing plug is inserted in the opening and treated again thermally so that in the opening the sealing plug (10) takes on the shape of use again.

### TECHNICAL FIELD

The invention relates to a method for sealing an opening in a component.

### BACKGROUND OF THE INVENTION

In the automotive field it is necessary during the vehicle assembly to seal apertures in the car body. For this purpose sealing plugs are used which have to fulfill certain quality requirements as to tightness and a firm fit after the mounting. However, these requirements are contrary to providing a simple mounting of the sealing plug. Generally, an optimal tightness and firm fit can be obtained only by means of a distinct press fit of the sealing plug which however complicates the insertion of the sealing plug in the car body aperture. On the other hand, sealing plugs with a simple mounting offer in most cases only a limited tightness and/or a limited firm fit. In any event, a high quality sealing of the car body apertures requires expenses, the reduction of which is desirable.

It is an object of the invention to provide a method for sealing an opening in a component which eliminates the contradiction described above in a cost-effective way.

### BRIEF SUMMARY OF THE INVENTION

In accordance with one aspect of the invention, a method for sealing an opening in a component comprises the following steps:
providing a sealing plug which has a mounting shape suitable for the insertion of the sealing plug in the opening,
inserting the sealing plug in the opening, and
treating the sealing plug thermally so that in the opening the sealing plug takes on a shape of use which differs from the mounting shape and ensures a sufficient tightness.

In accordance with a further aspect of the invention, a method for sealing an opening in a component comprises the following steps:
producing a sealing plug in a shape of use which ensures a sufficient tightness,
treating the sealing plug thermally so that the sealing plug takes on a mounting shape which differs from the shape of use,
inserting the sealing plug in the opening, and
again treating the sealing plug thermally so that in the opening the sealing plug substantially takes on the shape of use again.

The invention is based on the idea that it is possible to reshape the sealing plug during the mounting process at acceptable costs and that this leads to a considerable simplification of the mounting. The sealing plug in its shape of use then satisfies reliably the demands made as to the tightness and the firm fit. Due to the reshaping of the sealing plug in accordance with the invention it is not necessary anymore to make a compromise between the ease of mounting and the high quality standard of the sealing.

### BRIEF DESCRIPTION OF THE DRAWINGS

FIGS. 1a, 1b show perspective views of a sealing plug;

FIG. 2 shows a perspective sectional view of the sealing plug;

FIGS. 3a, 3b show a front view and a rear view, respectively, of the inserted sealing plug in its mounting shape; and

FIGS. 4a, 4b, 4c show a front view, a rear view and a lateral view, respectively, of the inserted sealing plug in its shape of use.

### DETAILED DESCRIPTION OF THE PREFERRED EMBODIMENTS

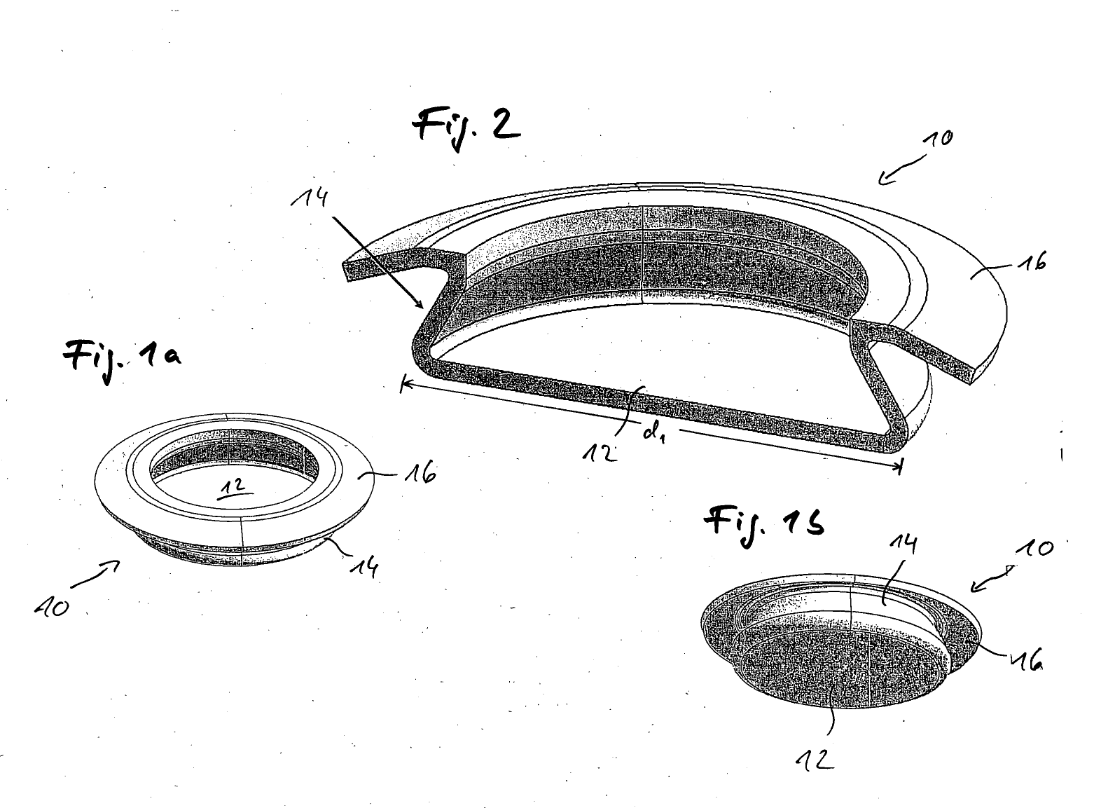

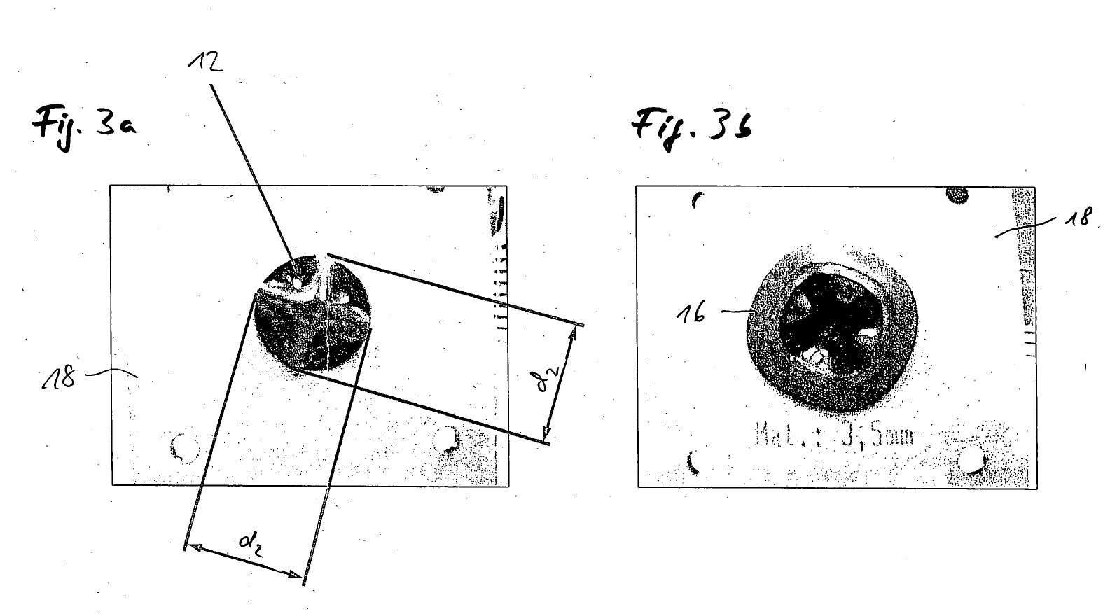

FIGS. 1 and 2 show a sealing plug 10 made of plastic material in a shape which is called shape of use in the following. The sealing plug 10 comprises a flat bottom 12 having a diameter d₁, a central portion 14 which extends from the bottom 12 and tapers like a truncated cone, and a collar 16 which is slightly inclined towards the bottom 12.

Starting with the bottom 12, the sealing plug 10 is to be inserted into a bore (opening) of a car body 18 by a mechanic during the vehicle mounting to reliably seal the opening. Prior to the insertion in the opening, the sealing plug 10 is treated thermally, more specifically heated. The sealing plug 10 thus takes on a mounting shape which can be seen in FIGS. 3a and 3b. The mounting shape differs from the shape of use particularly with respect to the bottom 12 and the central portion 14. In the embodiment shown, the bottom 12 has a clear camber in the form of a cross, and the diameter of the bottom 12 has diminished to a value of d₂<d₁. Accordingly to the cross shaped camber of the bottom 12, the collar 16 is not circular anymore, either. In this mounting shape, the sealing plug 10, compared to the shape of use, can be inserted in the opening of the car body 18 far more easily. In the mounting shape, the sealing plug 10 does however not fulfil the quality requirements as to the tightness and the firm fit.

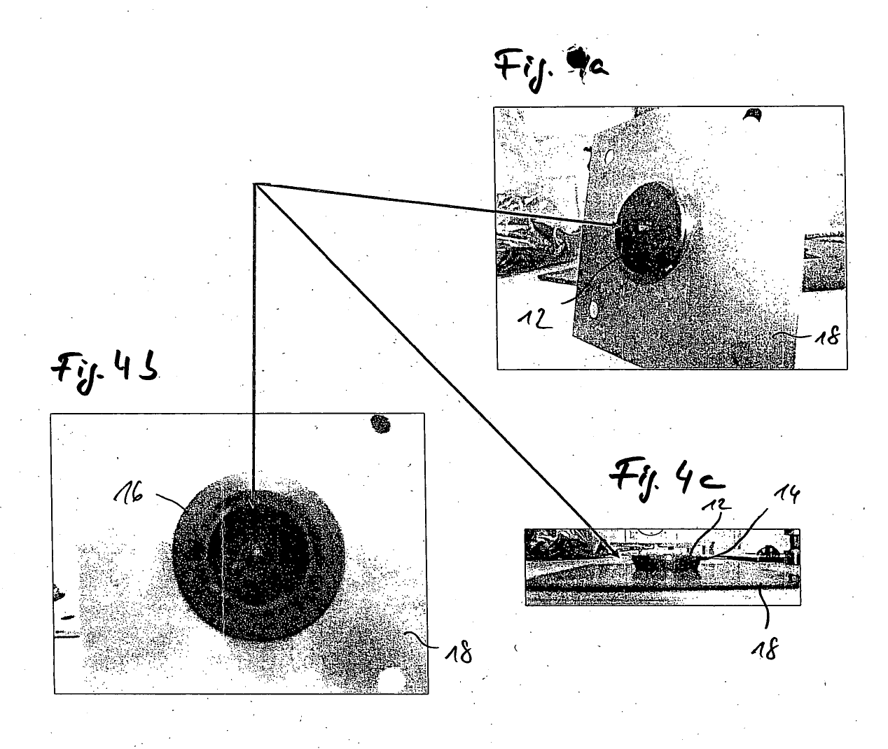

This is why the sealing plug 10 is converted to is initial shape of use again. For this purpose, the sealing plug 10 is heated again for approximately 10 minutes at a temperature of 180° in a furnace or by means of a hot-air blower. After this thermal treatment, the sealing plug 10 has in the opening substantially the shape shown in FIGS. 1 and 2 (cf. FIGS. 4a, 4b, 4c) again. The diameter of the bottom 12 corresponds approximately to the initial value d₁. In the mounted condition, the sealing plug 10 thus takes on its shape of use again, which ensures a sufficient tightness and a sufficient firm fit of the sealing plug 10 in the opening of the car body 18.

1. A method for sealing an opening in a component, the method comprising the following steps:
providing a sealing plug which has a mounting shape suitable for the insertion of the sealing plug in the opening,
inserting the sealing plug in the opening, and
treating the sealing plug thermally so that in the opening, the sealing plug takes on a shape of use which differs from the mounting shape and ensures a sufficient tightness.

2. The method according to claim 1, wherein the sealing plug is produced in the shape of use.

3. The method according to claim 2, wherein the sealing plug is treated thermally prior to the insertion in the opening so that the sealing plug takes on a mounting shape which differs from the shape of use.

4. The method according to claim 1, wherein the sealing plug is treated thermally in a furnace.

5. The method according to claim 1, wherein the sealing plug is treated thermally by a hot-air blower.

6. The method according to claim 1, wherein in the mounting shape at least one portion of the sealing plug has a smaller diameter than in the shape of use.

7. A method for sealing an opening in a component, the method comprising the following steps:
producing a sealing plug in a shape of use which ensures a sufficient tightness,
treating the sealing plug thermally so that the sealing plug takes on a mounting shape which differs from the shape of use,
inserting the sealing plug in the opening, and
again treating the sealing plug thermally so that in the opening the sealing plug substantially takes on the shape of use again.

8. The method according to claim 7, wherein the sealing plug is treated thermally in a furnace.

9. The method according to claim 7, wherein the sealing plug is treated thermally by a hot-air blower.

10. The method according to claim 7, wherein in the mounting shape at least one portion of the sealing plug has a smaller diameter than in the shape of use.
